(19) United States
(12) Patent Application Publication
(10) Pub. No.: US 2011/0302501 A1
(43) Pub. Date: Dec. 8, 2011

(54) CONTROL DEVICE AND CONTROL METHOD

(75) Inventor: Fumihiko Taguchi, Osaka (JP)

(73) Assignee: Panasonic Corporation, Osaka (JP)

(21) Appl. No.: 13/147,463

(22) PCT Filed: Feb. 24, 2010
(86) PCT No.: PCT/JP2010/001229

§ 371 Date: Aug. 2, 2011

(30) Foreign Application Priority Data
Feb. 26, 2009 (JP) 2009-043357

(51) Int. Cl. G06F 3/01; G06F 15/16

(52) U.S. Cl. 715/740

(57) ABSTRACT

A control device is connected to at least one objective device to be controlled via a network. The control device includes an operation control unit for acquiring a request to display a device list screen; a communication control unit for acquiring attribute data of the at least one objective device to be controlled; a first holding unit for holding the acquired attribute data; a second holding unit for holding function information of the control device; a determination unit for detecting the presence of different functions having the identical action based on the attribute data and the function information; a display control unit for displaying a device list screen provided with information indicating the presence of the different functions detected by the determination unit; and a control unit for, when the request to display the device list screen has been acquired, making the communication control unit acquire the attribute data, making the determination unit detect the presence of different functions having the identical action, and making the display control unit display the device list screen.

This application is a U.S. National Phase Application of PCT International Application PCT/7P2010/001229.

### TECHNICAL FIELD

The present invention relates to a control device and a control method, and more particularly, to a control device and a control method capable of informing the user that two or more devices perform the identical action, but as different functions.

### BACKGROUND ART

Some conventional information processing devices can identify and display both objective devices to be controlled connected to a control device and functions of the objective devices to be controlled (see, for example, Patent Literature 1). In such an information processing device, a TV as a control device displays, on its screen, objective devices to be controlled connected to the TV via a network. The objective devices to be controlled include a DVD recorder and other video recording devices. The network can use, for example, IEEE1394 or high-definition multimedia interface (HDMI).

On the other hand, a conventional control device shown in FIG. 15 can display all objective devices to be controlled on its screen whether or not they are actually connected to the control device. This allows the user to select a desired objective device to be controlled via a remote control. The connectable objective devices to be controlled are arranged around the oval shown in the screen. The user can move the position of each objective device to be controlled around the oval by operating the left and right keys of the remote control. In FIG. 15, the objective device to be controlled on the lower left is in focus. In this case, the user can start a function (such as a playback function for playing back recorded still images, video, or audio) of the objective device to be controlled in focus by performing a determination operation. The determination operation can be, for example, to press the determination key of the remote control.

A video recording device, which is an objective device to be controlled, however, may have a plurality of methods for playing back recorded videos because of the development of digital technology. Therefore, the TV as a control device can use the plurality of methods to play back videos recorded by a video recording device such as a digital camera or a movie. One method is to connect the TV and the video recording device via a network using, for example, HDMI, and to control the start of playing back videos by a control signal of the TV. Another method is, when the video recording device has a removable memory card as a recording medium, to move the memory card containing videos from the video recording device to the TV, and to start playing back videos according to the control sequence in the TV. These methods for playing back videos may be implemented in different video recording devices as the identical action, but as different functions. As a result, the user cannot recognize the presence of different functions having the identical action without separately tracing the menu hierarchy in each device. Thus, it is difficult for the user to understand the relation between the different functions having the identical action performed by different objective devices to be controlled.

Another problem is that with increasing variety of objective devices to be controlled that can be connected to a TV via the same network, the user has to perform a larger number of operations to select a desired objective device to be controlled. As an approach to solve this problem, only objective devices to be controlled that are actually connected to the network are displayed as in the information processing device of Patent Literature 1. As another approach, devices that can be connected to the control device are classified into categories as shown in FIG. 15, so that the user can select an objective device to be controlled from each category by a human interface. Neither approach, however, can prevent the user from performing a larger number of operations to select a desired objective device to be controlled with increasing variety of objective devices to be controlled that can be connected to a TV.

### CITATION LIST

### Patent Literature

Patent Literature 1: Japanese Patent Unexamined Publication No. 2001-067163

### SUMMARY OF THE INVENTION

The control device of the present invention, which is connected to at least one objective device to be controlled via a network, includes an operation control unit, a communication control unit, a first holding unit, a second holding unit, a determination unit, a display control unit, and a control unit. The operation control unit acquires a request input by a user to display a device list screen. The communication control unit acquires attribute data of the at least one objective device to be controlled via the network. The first holding unit holds the attribute data acquired by the communication control unit. The second holding unit holds function information of the control device. The determination unit detects the presence of different functions having the identical action based on the attribute data held by the first holding unit and the function information held by the second holding unit. The display control unit displays a device list screen provided with information indicating the presence of the different functions detected by the determination unit. When the operation control unit has acquired the request to display the device list screen, the control unit makes the communication control unit acquire the attribute data, makes the determination unit detect the presence of the different functions having the identical action, and makes the display control unit display the device list screen.

This structure makes the in-house device collaboration more user-friendly.

The control method of the present invention is a control method in a control device connected to at least one objective device to be controlled via a network. The control method includes acquiring a request input by a user to display a device list screen; acquiring and holding attribute data of the at least one objective device to be controlled via the network; detecting the presence of different functions having the identical action based on the held attribute data and the function information of the control device; providing information indicating the detected presence of the different functions; and displaying a device list screen.

### BRIEF DESCRIPTION OF DRAWINGS

FIG. 1 shows the overall structure of a control system according to a first exemplary embodiment of the present invention.

FIG. 2 is a block diagram of a control device according to the first exemplary embodiment.

FIG. 3 is a flowchart showing the operation procedure of the control device according to the first exemplary embodiment.

FIG. 4 shows a screen example in the first exemplary embodiment.

FIG. 5 is a block diagram of another example of the control device according to the first exemplary embodiment.

FIG. 6 is a flowchart showing the operation procedure of the other example of the control device according to the first exemplary embodiment.

FIG. 7 is a block diagram of another example of the control device according to the first exemplary embodiment.

FIG. 8 is a flowchart showing the operation procedure of the other example of the control device according to the first exemplary embodiment.

FIG. 9 is a block diagram of a control device according to a second exemplary embodiment of the present invention.

FIG. 10 is a flowchart showing the operation procedure of the control device according to the second exemplary embodiment.

FIG. 11 shows a screen example in the second exemplary embodiment.

FIG. 12A is a communication sequence diagram of how a control device according to a third exemplary embodiment of the present invention acquires attribute data and function information of objective devices to be controlled.

FIG. 12B shows an example of function information that the control device according to the third exemplary embodiment has acquired from the objective devices to be controlled.

FIG. 13 is another communication sequence diagram of how the control device according to the third exemplary embodiment acquires attribute data and function information of objective devices to be controlled.

FIG. 14 shows an example of a device description document (DDD) used in the third exemplary embodiment.

FIG. 15 shows a conventional screen example.

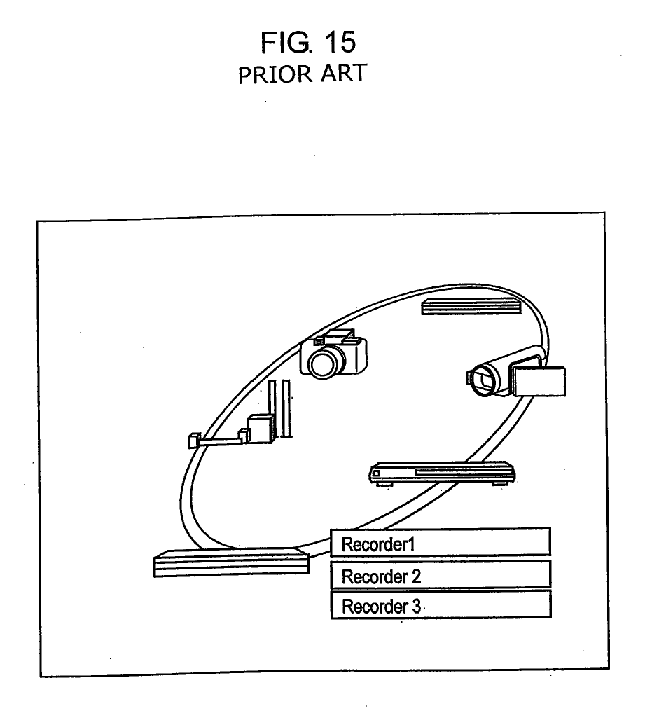

### DETAILED DESCRIPTION OF PREFERRED EMBODIMENTS

### First Exemplary Embodiment

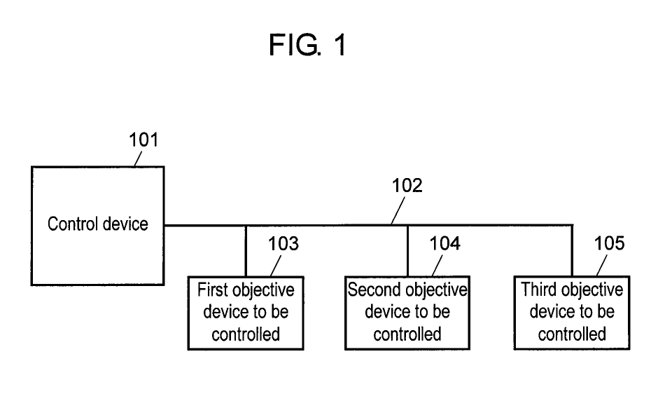

FIG. 1 shows the overall structure of a control system according to a first exemplary embodiment of the present invention. In the control system, control device 101 is connected to first objective device to be controlled 103, second objective device to be controlled 104, and third objective device to be controlled 105 via network 102. Control device 101 may be connected to at least one objective device to be controlled via network 102. Control device 101 controls first to third objective devices to be controlled 103 to 105 via network 102. Control device 101 can be, for example, a TV or set top box (STB). Network 102 can use, for example, IEEE1394, HDMI, or Digital Living Network Alliance (DLNA). First to third objective devices to be controlled 103 to 105 may be, for example, an optical disc recorder, a digital still camera, and a digital video camera (hereinafter also referred to as “movie”).

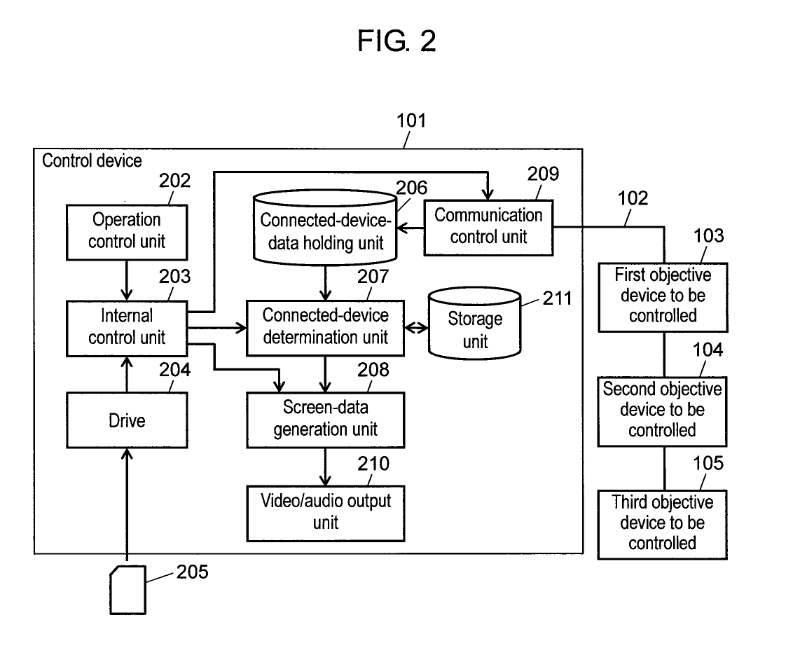

FIG. 2 is a block diagram of control device 101 according to the first exemplary embodiment. Control device 101 includes drive 204 into which memory card 205 is inserted or removed. Control device 101 has a memory-card playback function for playing back still image, audio, or video data stored in memory card 205. In control device 101, operation control unit 202 receives a user request from an input unit (not shown) such as a remote control, and performs a function corresponding to the user request. More specifically, operation control unit 202 acquires a request issued by the user to display a device list screen. Communication control unit 209 acquires attribute data of the objective devices to be controlled via network 102.

Assume that operation control unit 202 receives a request that video/audio output unit 210 should display a list of objective devices to be controlled that can be connected to network 102 and the connection status of each objective device to be controlled (a request to display a device list screen). In this case, control device 101 operates as follows. Upon receiving the request to display the device list screen from operation control unit 202, internal control unit 203 as a control unit makes communication control unit 209 acquire the attribute data. The attribute data contains the presence or absence of an objective device to be controlled connected to network 102, and the type of the objective device to be controlled. The term “type” in this case means a digital still camera, a movie, or other similar devices. Connected-device-data holding unit 206 as a first holding unit holds the attribute data of first objective device to be controlled 103 acquired by communication control unit 209 via network 102. Internal control unit 203 makes a request to generate configuration data necessary for the display of the screen (a screen generation request) to connected-device determination unit 207 and screen-data generation unit 208. Connected-device determination unit 207 as a determination unit detects the presence of different functions having the identical action. This detection is performed based on the function information contained in the attribute data held by connected-device-data holding unit 206 as the first holding unit, and the function information that is held by storage unit 211 as a second holding unit and that is executable by control device 101. Then, internal control unit 203 makes connected-device determination unit 207 determine whether first objective device to be controlled 103 connected via network 102 has a different function executable by control device 101. When first objective device to be controlled 103 has the different function, internal control unit 203 sends a report message indicating the presence of different functions (a report about the presence of different functions having the identical action) to screen-data generation unit 208 as a display control unit. Screen data generation unit 208 generates screen display data based on the screen generation request from internal control unit 203 and the report about the presence of different functions having the identical action from connected-device determination unit 207. Screen data generation unit 208 then outputs the device list screen to video/audio output unit 210 which displays the screen. Screen data generation unit 208 as the display control unit displays the device list screen which is provided with information indicating the presence of the different function detected by connected-device determination unit 207 as the determination unit.

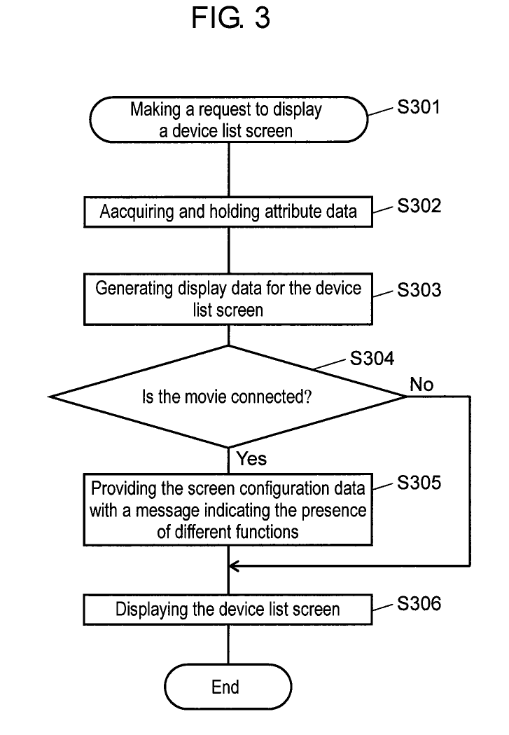

FIG. 3 is a flowchart showing the operation procedure of control device 101. In this flowchart, control device 101 shown in FIG. 2 is a TV, network 102 uses HDMI, and first objective device to be controlled 103 is a movie. Assume that the user makes a request to the TV to display a device list screen showing objective devices to be controlled connected to HDMI (Step S301). The TV acquires and holds attribute data (including the type) of the movie connected to HDMI (Step S302). The TV generates display data for the device list screen based on the acquired attribute data (Step S303). The procedure in which the TV acquires the attribute data (including the type) of the movie connected to network 102 such as HDMI is described later.

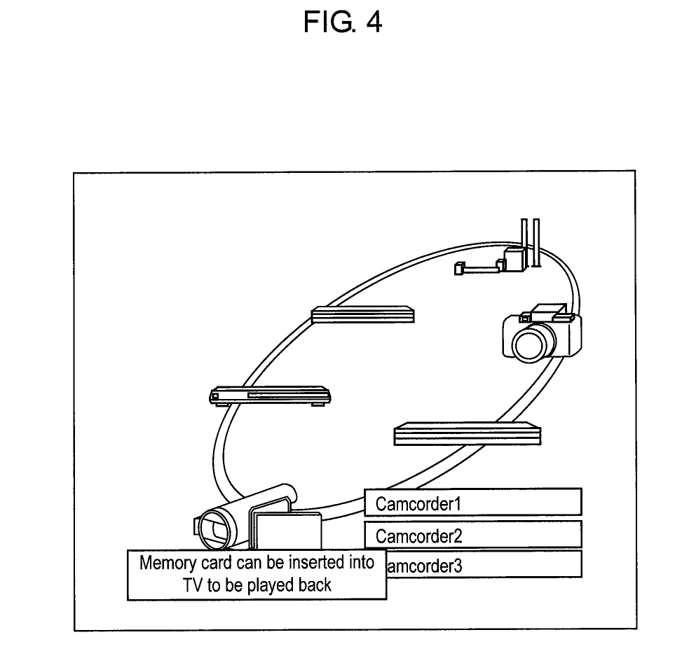

The TV determines whether the movie is connected to network 102 (Step S304). When the movie is connected (Yes in Step S304), the TV can play back the videos recorded by the movie using the TV's memory-card playback function. In this case, the TV provides the screen configuration data with a message informing the user of the presence of different functions having the identical action (Step S305). The message can be, for example, “Memory card can be inserted into TV to be played back.” as shown in FIG. 4. The TV displays the message on its screen (Step S306). As a result, the user can recognize that the TV has a memory-card playback function. Note that the condition: “Is the movie connected?” in Step S304 may be determined by identifying the model number of the movie.

As described above, the control method of the present exemplary embodiment includes acquiring a request to display a device list screen made by a user; acquiring and holding attribute data of an objective device to be controlled via network 102; detecting the presence of different functions having the identical action based on the held attribute data and the function information of control device 101; providing information indicating the detected presence of the different function; and displaying a device list screen. This enables the user to select a desired objective device to be controlled with less number of operations.

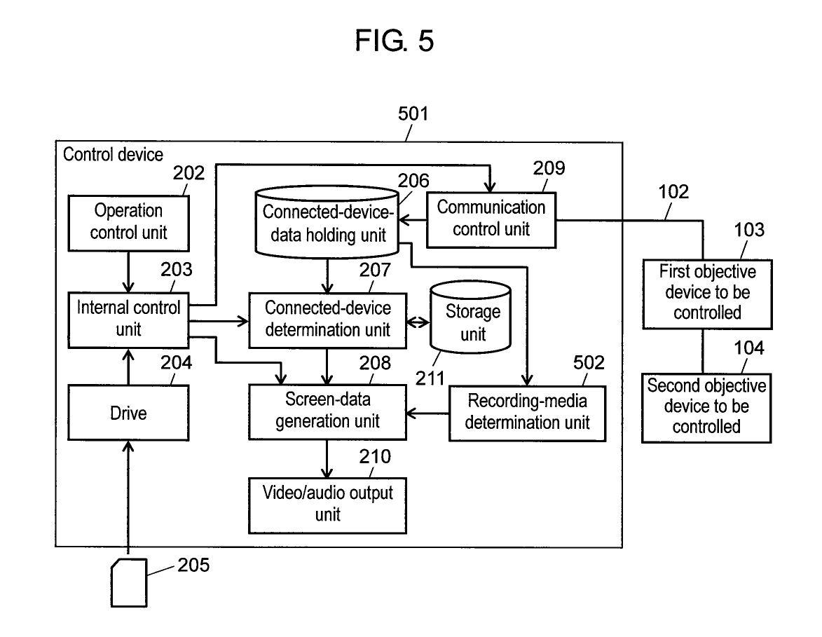

FIG. 5 is a block diagram of control device 501 as another example according to the first exemplary embodiment. Control device 501 is connected to first objective device to be controlled 103 and second objective device to be controlled 104 via network 102. Control device 501 includes recording-media determination unit 502 in addition to the components of control device 101 shown in FIG. 2. Communication control unit 209 can acquire attribute data which includes not only the types of the objective devices to be controlled connected to network 102, but also detailed information such as whether the objective devices to be controlled have a recording function or not, and their recording media.

Recording-media determination unit 502 reports about the presence of different functions having the identical action to screen-data generation unit 208 upon determining that first and second objective device to be controlled 103 and 104 use the same kind of recording media. Screen data generation unit 208 determines whether the report message should be sent to the user. This determination is made based on the following two reports. One is the report from connected-device determination unit 207 about the presence of different functions having the identical action (control device 501 and the objective device to be controlled perform the identical action, but as different functions). The other is the report from recording-media determination unit 502 about the presence of different functions having the identical action (the objective devices to be controlled perform the identical action, but as different functions).

This function of recording-media determination unit 502 may alternatively be owned by connected-device determination unit 207 as the determination unit. More specifically, the determination unit of control device 501 may detect the presence of different functions having the identical action based on a plurality of pieces of attribute data held by the first holding unit. This structure allows the user to easily use functions owned by a plurality of objective devices to be controlled.

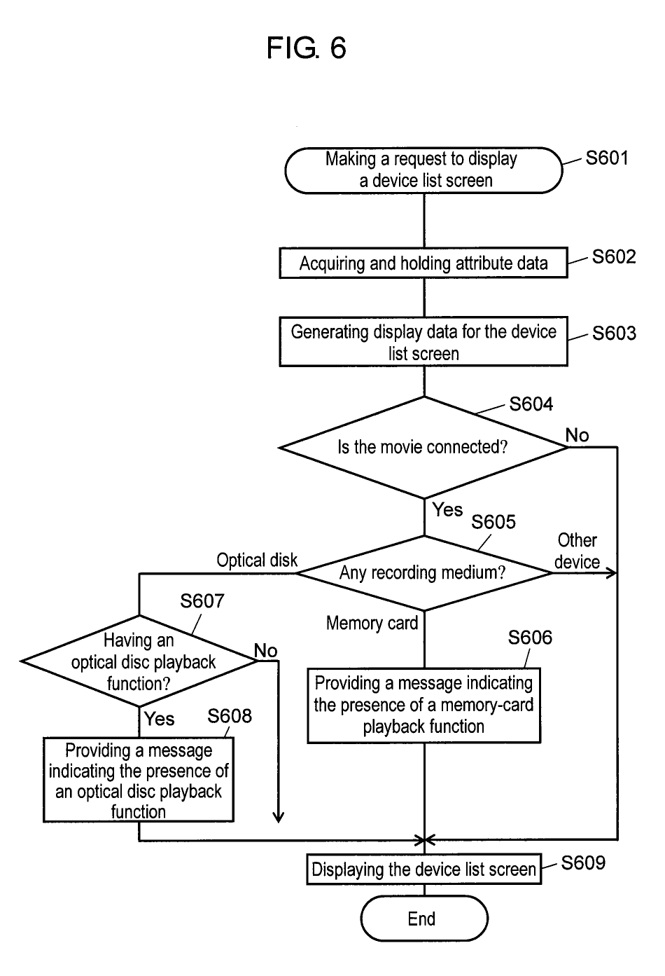

FIG. 6 is a flowchart showing the operation procedure of control device 501. In this flowchart, control device 501 shown in FIG. 5 is a TV, network 102 uses HDMI, first objective device to be controlled 103 is a movie capable of using a memory card, and second objective device to be controlled 104 is a stationary optical disc player.

Assume that the user makes a request to the TV to display a device list screen showing objective devices to be controlled connected to HDMI (Step S601). The TV acquires and holds attribute data (including detailed information such as the type and the recording medium) of the objective devices to be controlled connected to HDMI (Step S602). The TV generates display data for the device list screen based on the acquired attribute data (Step S603).

The TV determines whether the movie is connected to network 102 (Step S604). When the movie is connected (Yes in Step S604), the TV determines whether the movie has a memory card, an optical disc, or other device as a recording medium (Step S605). When the movie has a memory card (“memory card” in Step S605), the TV can play the videos recorded by the movie by using the TV's memory-card playback function. In this case, the TV provides a message informing the user of the presence of functions having the identical action (Step S606). The message can be, for example, “Memory card can be inserted into TV to be played back.” The TV displays the generated screen data on its screen (Step S609). As a result, the user can recognize that the TV has a memory-card playback function.

Assume, on the other hand, that first objective device to be controlled 103 is a movie using an optical disc (“optical disc” in Step S605), the videos recorded by the movie can be played back on an optical disc player having an optical disc playback function. In this case, the TV determines whether the movie has an optical disc playback function (Step S607). When the movie has the optical disc playback function (Yes in Step S607), the TV provides a message informing the user of the presence of a device which performs the identical action, but as a different function. The message can be, for example, “The optical disc can be inserted into the optical disc player to be played back.” (Step S608). The TV displays the generated screen data on its screen (Step S609) in the same manner as above. As a result, the user can use the optical disc player already connected to HDMI. This allows the user to recognize that the data can be played back without additional procedure to connect the movie and the TV via HDMI.

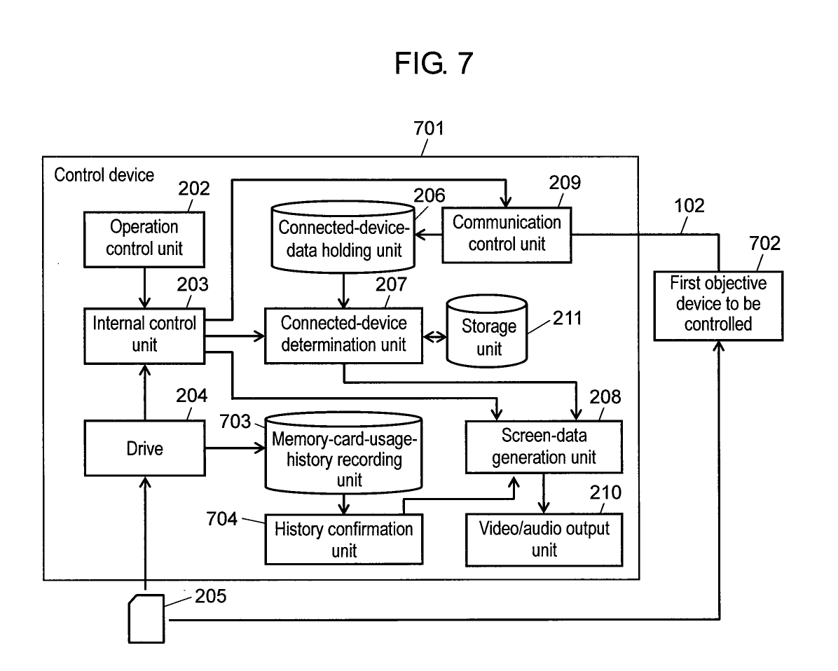

FIG. 7 is a block diagram of control device 701 as another example of the first exemplary embodiment. Control device 701 includes memory-card-usage-history recording unit 703 as a third holding unit, and history confirmation unit 704 as a suppression unit in addition to the components of control device 101 shown in FIG. 2. First objective device to be controlled 702 can use memory card 205, and has the same memory-card playback function as control device 701. When the data contained in memory card 205 is used in drive 204, control device 701 records the history to memory-card-usage-history recording unit 703. This information is held even after memory card 205 is removed from drive 204. When data for a device list screen is generated, history confirmation unit 704 refers to the data recorded in memory-card-usage-history recording unit 703. When a usage history is present, history confirmation unit 704 makes a suppression request to suppress the report message to screen-data generation unit 208. Screen-data generation unit 208 considers, from the suppression request, that the user already knows that control device 701 has a function having the identical action as first objective device to be controlled 702. Therefore, screen-data generation unit 208 displays a screen not containing the report message even if receiving the report about the presence of different functions having the identical action from connected-device determination unit 207.

As described above, control device 701 includes the third holding unit for storing the usage history of a predetermined function contained in the function information of control device 701, and the suppression unit for outputting a suppression request to suppress the predetermined function based on the usage history held by the third holding unit. Upon receiving the suppression request from the suppression unit, the display control unit displays the device list screen not containing the information indicating the presence of the different functions detected by the determination unit. Thus, control device 701 prevents excessive information display.

When the movie stores data to memory card 205 in the above-described procedure, information unique to the movie such as a model name and a MAC address may also be stored as its original file. In this case, the original file in memory card 205 is copied to control device 701 when the user moves memory card 205 to memory card drive 204 of the TV. Then, the information may be compared with the information unique to the connected device that can be acquired via network 102 when screen data is generated. The report message may be suppressed only when the two pieces of information contain the same data.

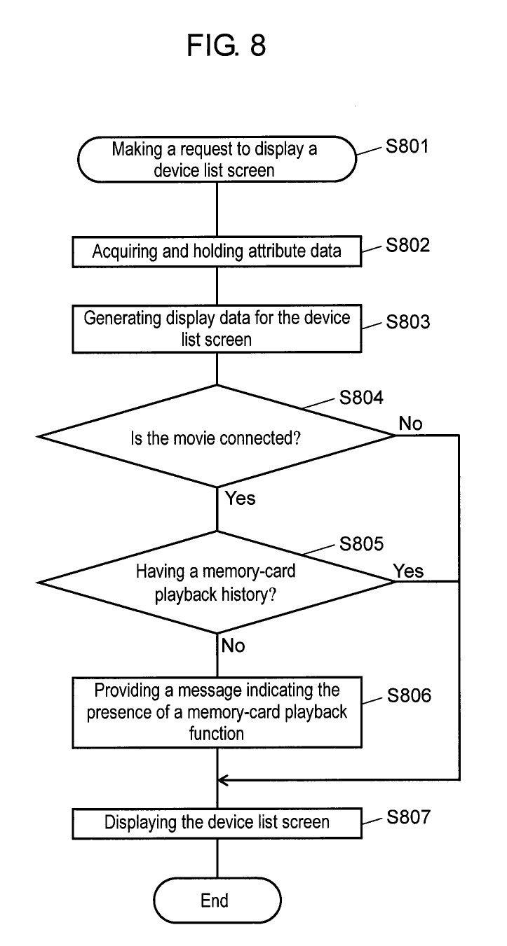

FIG. 8 is a flowchart showing the operation procedure of control device 701 according to the first exemplary embodiment. In this flowchart, control device 701 shown in FIG. 7 is a TV, network 102 uses HDMI, first objective device to be controlled 702 is a movie capable of using memory card 205.

Assume that the user makes a request to the TV to display a device list screen showing objective devices to be controlled connected to HDMI (Step S801). Similar to the flowcharts in FIGS. 3 and 6, the TV acquires and holds attribute data (including detailed information such as the type and the recording medium) of the objective devices to be controlled connected to HDMI (Step S802). And the TV generates display data for the device list screen (Step S803).

The TV determines whether the movie is connected to network 102 (Step S804). When the movie is connected to HDMI (Yes in Step S804), the TV determines whether the movie has a memory-card playback history (Step S805). When there is no playback history (No in Step S805), the TV provides a message informing the user of the presence of different functions having the identical action and displays the message on its screen (Steps S806 and S807). The message can be, for example, “Memory card can be inserted into TV to be played back.” When there is a playback history, on the other hand, (Yes in Step S805), the user is considered to already know that the TV has a memory-card playback function. Then, the TV displays the device list screen not including the message (Step S807). Thus, the TV prevents providing excessive information to the user.

Note that the report message can be any means that can provide the user with information, such as an icon or audio.

In the present exemplary embodiment, when the user is using a function owned by an objective device to be controlled, the report message informs the user of the presence of a different function having the identical action owned by control device 701 and/or by another objective device to be controlled. Alternatively, when the user is using a function owned by control device 701, the report message may inform the user of the presence of a different function having the identical action owned by an objective device to be controlled.

### Second Exemplary Embodiment

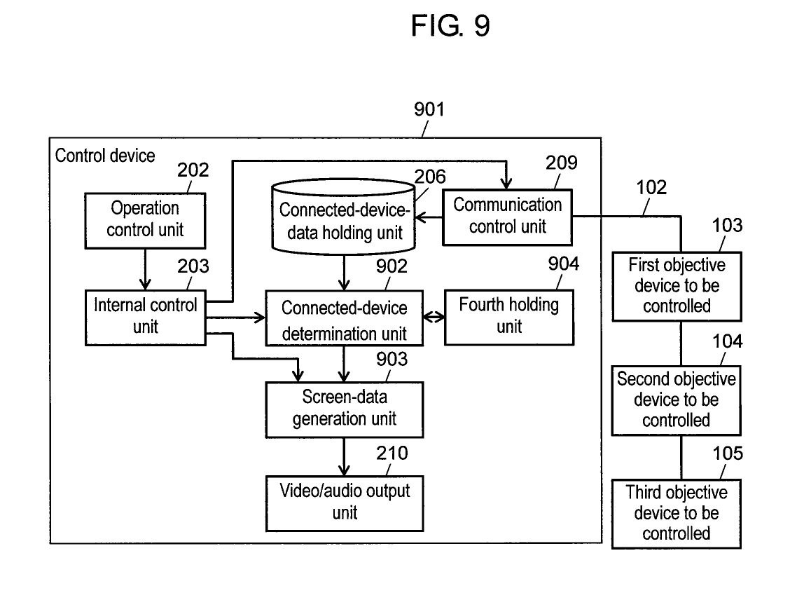

FIG. 9 is a block diagram of control device 901 according to a second exemplary embodiment of the present invention. Control device 901 is connected to first, second, and third objective devices to be controlled 103, 104, and 105 via network 102. Control device 901 may be connected to at least one objective device to be controlled via network 102. Operation control unit 202 receives a request from the user as a remote control signal, and outputs an instruction to internal control unit 203 as the control unit. Assume that operation control unit 202 receives a request that video/audio output unit 210 should display a list of objective devices to be controlled connected to network 102 (a request to display a device list screen). In this case, control device 901 operates as follows.

Upon receiving the request to display the device list screen, internal control unit 203 makes communication control unit 209 acquire the attribute data. The attribute data contains the presence or absence of an objective device to be controlled connected to network 102, and the type of the objective device to be controlled. Then, connected-device-data holding unit 206 as the first holding unit holds the attribute data thus acquired. The term “type” in this case means a digital still camera, a movie, or other similar devices. Internal control unit 203 makes a request to generate configuration data necessary for the display of the screen (a screen generation request) to connected-device determination unit 902 as a generation unit and screen-data generation unit 903 as a display control unit. Connected-device determination unit 902 makes fourth holding unit 904 hold, as final focus location information, the location information of the objective device to be controlled that is in focus when the list starts to be displayed. In the present exemplary embodiment, the objective device to be controlled that is in focus when the list starts to be displayed is first objective device to be controlled 103.

Connected-device determination unit 902 as the generation unit specifies third objective device to be controlled 105 from the attribute data stored in connected-device-data holding unit 206. Third objective device to be controlled 105 is specified because it is the most distant from first objective device to be controlled 103 that is in focus when the list starts to be displayed, and it needs the largest number of operations until it is in focus. Connected-device determination unit 902 then defines a shortcut key for the most distant third objective device to be controlled 105 based on its own determination. Thus, connected-device determination unit 902 generates the shortcut key to select the specified objective device to be controlled. Sreen data generation unit 903 provides the screen data with a method for operating the shortcut key, and makes video/audio output unit 210 display the screen.

As described above, screen-data generation unit 903 as the display control unit displays the device list screen which is provided with the shortcut key generated by the generation unit. When operation control unit 202 acquires the request to display a device list screen, the control unit makes communication control unit 209 acquire the attribute data. The control unit also makes the specification unit specify the objective device to be controlled that needs the largest number of operations until it is in focus. Then, the control unit makes the display control unit display the device list screen. This allows the user to select a desired objective device to be controlled with less number of operations even when there are many objective devices to be controlled.

The procedure in connected-device determination unit 902 can be performed by using another condition such as to assign a shortcut key to a specific type of objective device to be controlled when it is connected. In the above description, one shortcut key is used; however, more shortcut keys may be used when ten or more objective devices to be controlled are connected. The number of shortcut keys can be, for example, one third or one fourth the number of objective devices to be controlled. This allows the user to select a desired objective device to be controlled with less number of operations even when many objective devices to be controlled are connected.

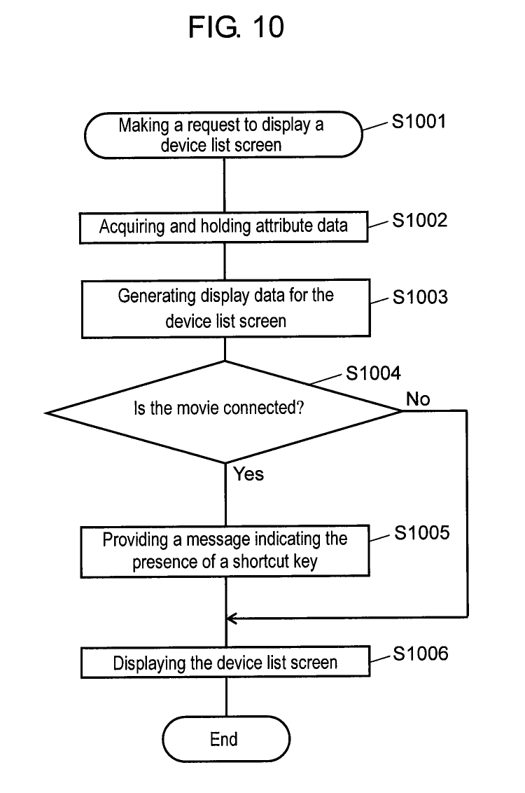

FIG. 10 is a flowchart showing the operation procedure of control device 901. Control device 901 shown in FIG. 9 is a TV, network 102 uses HDMI, first and second objective devices to be controlled 103 and 104 are DVD recorders, and third objective device to be controlled 105 is a movie. On the device list screen of the TV, the device used the last time HDMI was used is determined to be the first device to be selected.

If the user tries to display the device list screen again by additionally connecting the movie to HDMI after the use of the DVD recorder that is continuously connected to the TV, the focus falls on the DVD recorder. This causes the user to perform a number of remote control operations until he/she selects a desired movie. This condition can be avoided by preparing a shortcut key for the movie which is connected to HDMI only when needed (for example, assigning a red button on the remote control of the digital TV). Note that the movie in this case is assumed to be an objective device to be controlled that needs the largest number of operations until it is in focus, and that is determined based on the final focus information.

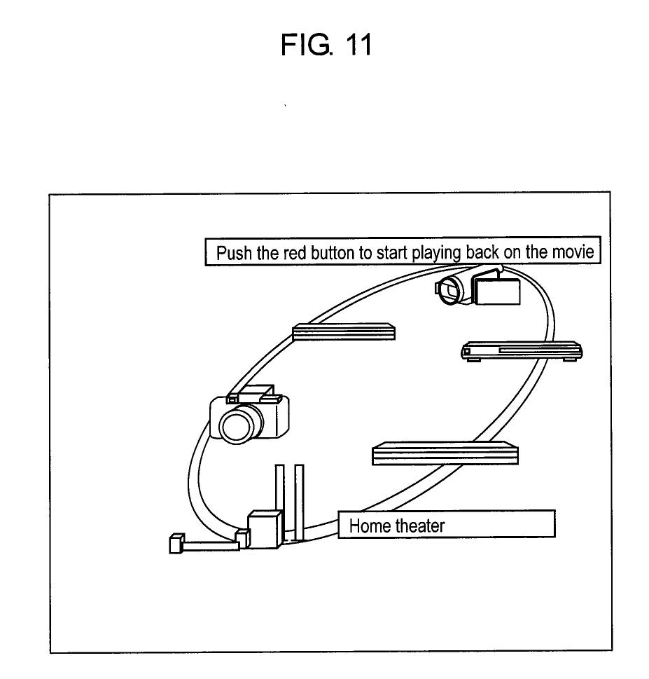

Assume that the user makes a request to the TV to display a device list screen showing devices connected to HDMI (Step S1001). The TV acquires and holds attribute data of the objective devices to be controlled connected to HDMI (Step S1002). The TV generates display data for the device list screen (Step S1003). The TV determines whether the movie is connected to HDMI (Step S1004). When the movie is connected to HDMI (Yes in Step S1004), the TV provides the screen data with a report message indicating the presence of a shortcut key (Step S1005). The message can be, for example, “Push the red button to start playing back on the movie.” as shown in FIG. 11. The TV displays the device list screen (Step S1006).

As described above, the control method of the present exemplary embodiment includes the following steps: a step of specifying the objective device to be controlled that needs the largest number of operations until it is in focus based on the held attribute data and the final focus information held in control device 901, and generating a shortcut key for selecting the objective device to be controlled thus specified; and a step of providing the generated shortcut key. This allows the user to select a desired objective device to be controlled with less number of operations.

Pushing the red button can result, for example, in placing the movie in focus so as to display the device list screen again, or starting playing back on the movie.

Even if a desired objective device to be controlled is not the objective device to be controlled that needs the largest number of operations until it is in focus, the user can use the generated shortcut key to select the desired objective device to be controlled with less number of operations.

### Third Exemplary Embodiment

In the first and second exemplary embodiments of the present invention, control devices 101, 501, 701, and 901 are connected to at least one objective device to be controlled via network 102, which can use, for example, IEEE1394, HDMI, or DLNA. In addition, communication control unit 209 acquires the attribute data and function information of the objective device to be controlled via network 102. The present exemplary embodiment describes a specific procedure for acquiring them. This procedure can be applied to control devices 101, 501, 701, and 901 of the first and second exemplary embodiments.

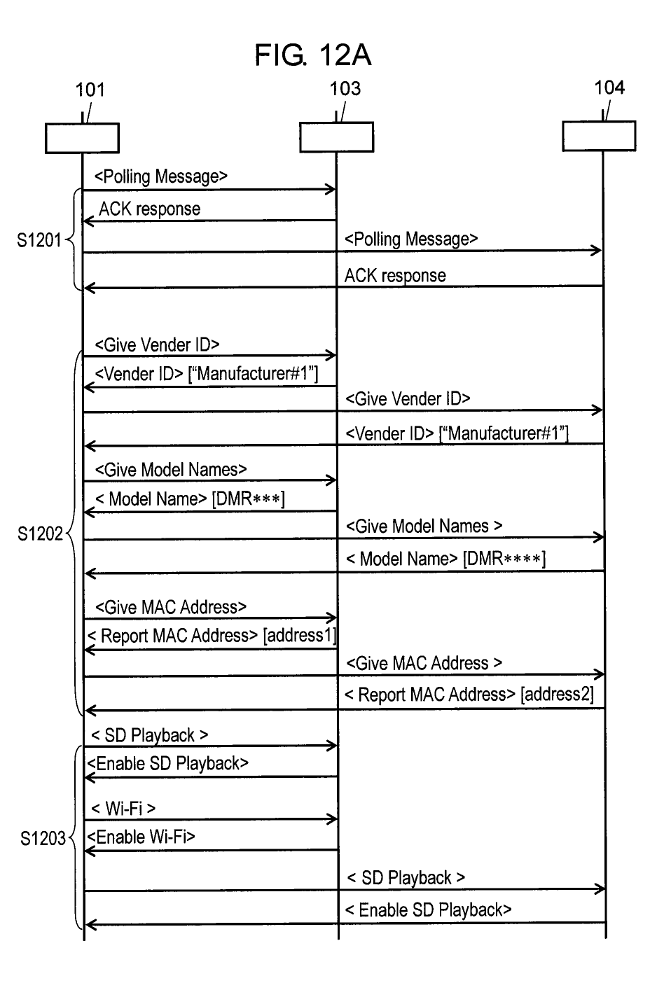

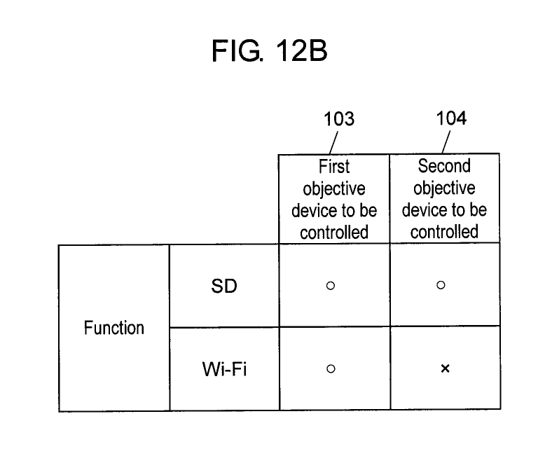

In the following description, control device 101 shown in FIG. 2 uses HDMI as network 102. FIG. 12A is a communication sequence diagram of how control device 101 according to the third exemplary embodiment acquires attribute data and function information of objective devices to be controlled. For easier explanation, control device 101 in FIG. 12A is connected only to first and second objective devices to be controlled 103 and 104 via HDMI as network 102. FIG. 12B shows an example of function information that control device 101 of the third exemplary embodiment has acquired from the objective devices to be controlled.

As shown in FIG. 12A, control device 101 first polls first and second objective devices to be controlled 103 and 104. In response to the polling, first and second objective devices to be controlled 103 and 104 each send an acknowledgment (ACK) response (sequence S1201). In sequence S1201, control device 101 recognizes that first and second objective devices to be controlled 103 and 104 are connected to network 102. Thus, sequence S1201 is a communication sequence of the device recognition process of control device 101.

Next, control device 101 performs a process for acquiring device information (sequence S1202) as follows. First, control device 101 sends a command <Give Vender Id> to first and second objective devices to be controlled 103 and 104. In response to the command, first and second objective devices to be controlled 103 and 104 each send the manufacture's name such as “manufacturer #1”. Next, control device 101 sends a command <Give Model Names> to first and second objective devices to be controlled 103 and 104. In response to the command, first and second objective devices to be controlled 103 and 104 each send a model name such as “DMR***”. Control device 101 then sends a command <Give MAC Address> to first and second objective devices to be controlled 103 and 104. In response to the command, first and second objective devices to be controlled 103 and 104 each send a Media Access Control (MAC) address which contains, for example, “address 1 or address 2”. Addresses 1 and 2 are addresses assigned to first and second objective devices to be controlled 103 and 104, respectively, on network 102. Thus, control device 101 acquires the device information of first and second objective devices to be controlled 103 and 104.

Then, control device 101 performs a process for acquiring information about the functions owned by the devices (sequence S1203) as follows. First, control device 101 sends an HDMI extension command <SD Playback> to first and second objective devices to be controlled 103 and 104, and another HDMI extension command <Wi-Fi> to first objective device to be controlled 103. The commands can be defined by each manufacture. In response to the command, first and second objective devices to be controlled 103 and 104 each send, for example, <Enable SD Playback>. This indicates that first and second objective devices to be controlled 103 and 104 each have an SD-card-memory playback function. First objective device to be controlled 103 further sends, for example, <Enable Wi-Fi>. This indicates that first objective device to be controlled 103 has a Wi-Fi (high-speed wireless LAN) function.

By the above-described process for acquiring the functions owned by the devices as shown in FIG. 12B, control device 101 recognizes that first objective device to be controlled 103 has both the SD-card-memory playback function and the Wi-Fi function, and that second objective device to be controlled 104 has the SD-card-memory playback function only.

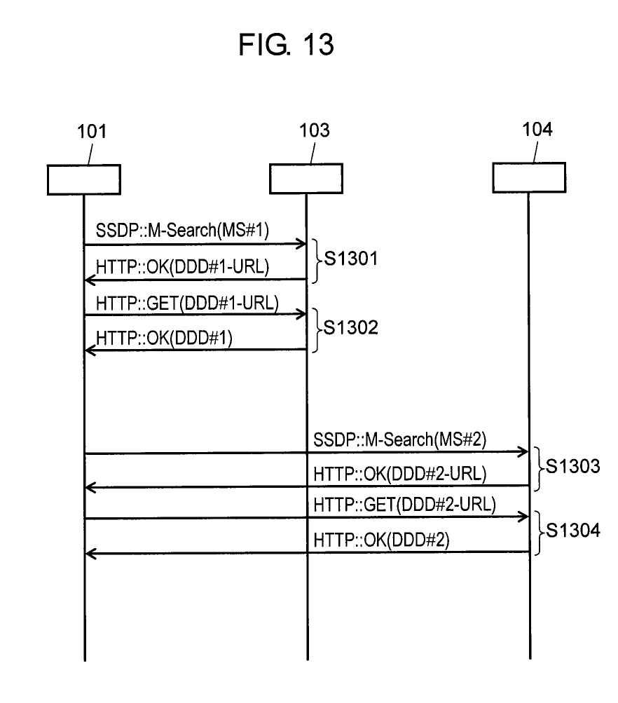

The following is a description of how control device 101 uses DLNA as network 102. FIG. 13 is another communication sequence diagram of how control device 101 according to the third exemplary embodiment acquires attribute data and function information of objective devices to be controlled. For easier explanation, control device 101 in FIG. 13 is connected only to first and second objective devices to be controlled 103 and 104 via DLNA as network 102.

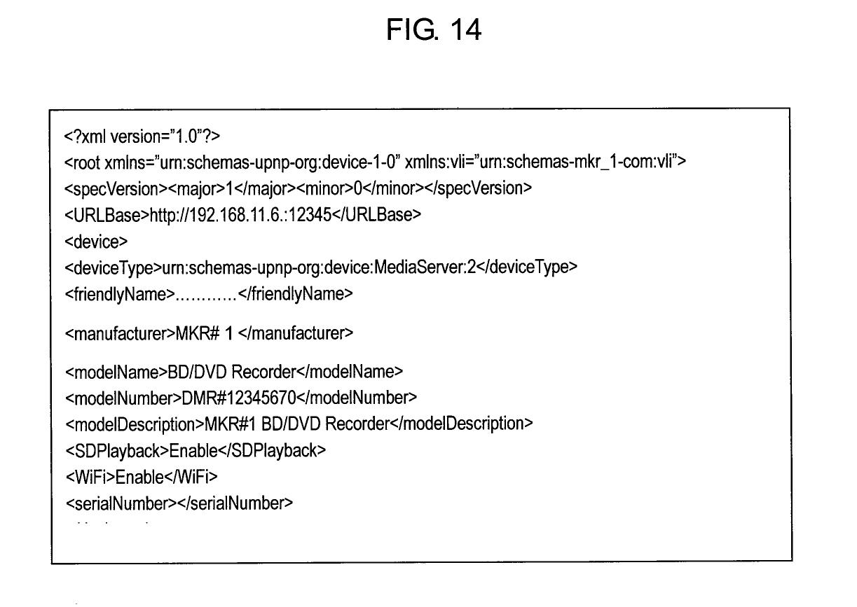

As shown in FIG. 13, first, control device 101 multicasts a search request to first and second objective devices to be controlled 103 and 104, which are media servers. In this case, first and second objective devices to be controlled 103 and 104 are referred to as the media servers MS#1 and MS#2, respectively. In response to the search request, the media servers unicast the URLs of DDD#1 and DDD#2, respectively, to control device 101 (sequences S1301 and S1303). DDD#1 and DDD#2 indicate device description documents (DDDs) corresponding to first and second objective devices to be controlled 103 and 104, respectively. The DDD contains device information such as a manufacture's name, a model name, attribute data and function information of a device as shown in the example of FIG. 14.

Control device 101 acquires DDD#1 which corresponds to first objective device to be controlled 103 (sequence S1302), and DDD#2 which corresponds to second objective device to be controlled 104 (sequence S1304).

The DDD shown in FIG. 14 represents DDD#1 corresponding to first objective device to be controlled 103. Thus, control device 101 recognizes that first objective device to be controlled 103 has an SD-card-memory playback function from <SDPlayback>Enable</SDPlayback> described in the DDD#1. Control device 101 also recognizes that first objective device to be controlled 103 has a Wi-Fi (high-speed wireless LAN) function from <WiFi>Enable</WiFi> described in DDD#1.

As described hereinbefore, control device 101 can acquire attribute data and function information of at least one objective device to be controlled via HDMI or DLNA as network 102. Control device 101 then can inform the user of different functions having the identical action according to the attribute data and function information acquired from the objective device to be controlled and the function information of control device 101.

### INDUSTRIAL APPLICABILITY

The control device of the present invention provides the user with information about available functions at each selection step so that the user can select a desired device with less number of operations. This control device is useful in the environment in which a number of multifunctional devices are connected.

### REFERENCE MARKS IN THE DRAWINGS

101, 501, 701, 901 control device
102 network
103, 702 first objective device to be controlled
104 second objective device to be controlled
105 third objective device to be controlled
202 operation control unit
203 internal control unit
204 drive
205 memory card
206 connected-device-data holding unit
207, 902 connected-device determination unit
208, 903 screen-data generation unit
209 communication control unit
210 video/audio output unit
211 storage unit
502 recording-media determination unit
703 memory-card-usage-history recording unit
704 history confirmation unit

1. A control device connected to an objective device to be controlled via a network, the control device comprising:
an operation control unit for acquiring a request input by a user to display a device list screen;
a communication control unit for acquiring attribute data of the objective device to be controlled via the network;
a first holding unit for holding the attribute data acquired by the communication control unit;
a second holding unit for holding function information of the control device;
a determination unit for detecting a presence of different functions having an identical action based on the attribute data held by the first holding unit and the function information held by the second holding unit;
a display control unit for displaying a device list screen provided with information indicating the presence of the different function detected by the determination unit; and
a control unit for, when the operation control unit has acquired the request to display the device list screen,
making the communication control unit acquire the attribute data,
making the determination unit detect the presence of the different functions having the identical action, and
making the display control unit display the device list screen.

2. The control device according to claim 1, wherein
the determination unit detects the presence of the different functions having the identical action based on a plurality of pieces of the attribute data held by the first holding unit.

3. The control device according to claim 1, further comprising:
a third holding unit for storing a usage history of a predetermined function contained in the function information of the control device; and
a suppression unit for outputting a suppression request to suppress the predetermined function based on the usage history held by the third holding unit,
wherein
upon receiving the suppression request from the suppression unit, the display control unit displays the device list screen not containing the information indicating the presence of the different functions detected by the determination unit.

4. The control device according to claim 1, wherein
the network uses HDMI (High-Definition Multimedia Interface); and
the communication control unit acquires the attribute data as a response to an HDMI extension command.

5. The control device according to claim 1, wherein
the network uses DLNA (Digital Living Network Alliance); and
the communication control unit acquires the attribute data contained in DDD (Device Description Document) information of DLNA.

6. A control method of a control device connected to an objective device to be controlled via a network, the control method comprising:
acquiring a request input by a user to display a device list screen;
acquiring and holding attribute data of the objective device to be controlled via the network;
detecting a presence of different functions having an identical action based on the held attribute data and the function information of the control device;
providing information indicating the detected presence of the different functions; and
displaying the device list screen.
